(19) United States
(12) Patent Application Publication
(10) Pub. No.: US 2008/0124681 A1
(43) Pub. Date: May 29, 2008

(54) Automatic tooth movement measuring method employing three dimensional reverse engineering technique

(75) Inventor: Bong-Kuen Cha, Gangneung-si (KR)

Correspondence Address: BACON & THOMAS, PLLC, 625 SLATERS LANE, FOURTH FLOOR, ALEXANDRIA, VA, 22314, US

(73) Assignee: Kangnung National University Industry Academy Corporation Group, Kangnung-si (KR)

(21) Appl. No.: 11/896,790

(22) Filed: Sep. 6, 2007

(30) Foreign Application Priority Data
Nov. 29, 2006 (KR) 10-2006-0118667

(51) Int. Cl. A61C 11/00; A61C 19/045; G06F 17/00

(52) U.S. Cl. 433/215; 703/7

(57) ABSTRACT

The present invention relates to an automatic tooth movement measuring method employing a three dimensional reverse engineering technique; and, more particularly, to an automatic tooth movement measuring method employing three dimensional reverse engineering technique, wherein a tooth movement measuring device capable of measuring a movement status of teeth before and after orthodontic treatment by spatially coordinating a three dimensional digital model of the tooth. According to the present invention, the tooth movement measuring device forms two three dimensional models which change corresponding to the point of time and applies a space coordinate to each model. And, by applying a technique superimposing each model, the tooth movement can be measured quantitatively and qualitatively. And, in accordance with the present invention, the tooth movement measuring device is capable of quantitatively and qualitatively measuring the tooth movement by applying space coordinates to the three dimensional digital model by a laser beam scanning without requiring a patient to be exposed to a huge amount of irradiation by such as a computer tomography in measuring the movement of teeth.

### FIELD OF THE INVENTION

The present invention relates to an automatic tooth movement measuring method employing a three dimensional reverse engineering technique; and, more particularly, to an automatic tooth movement measuring method employing three dimensional reverse engineering technique, wherein a tooth movement measuring device capable of measuring a movement status of teeth before and after orthodontic treatment by spatially coordinating a three dimensional digital model of the tooth.

### DESCRIPTION OF RELATED ART

A three dimensional reverse engineering technique is generating a virtual three dimensional digital model after coordinating in a three dimensional space in a computer by scanning using a three dimensional scanner. This means making a conventional orthodontic impression taking process into a data capable of processing by computerizing.

In dental medical fields, especially in an area of orthodontics, three dimensionally reproducing an anatomic maxillary or mandibular structure or shape of teeth of a patient is a basic means in diagnosing and evaluating of a treatment result. More than one hundred years, in dentistry, it has been done by a plaster cast which is made by being directly taken with impression materials from a patient. The impression taking process can cause lot of clinical problems such as waste of material, cross infection during the impression taking process, possibility of damage of a produced model, and storage.

To solve these problems, a Korean patent application No. 10-2001-0012088 provides a method for forming an orthodontic brace, the method for forming an orthodontic brace, first transforms a diagnosis information of a patient into a data through an input device and inputs and saves the data to a computer. Henceforth, a growth direction and the remaining growth amount is determined by using a cephalometric radiograph and a handwrist radiograph. And also, finally, it is possible to select orthodontic braces such as arch wire and elastic members in order to perform an orthodontic treatment with an optimized pressure by simulating an exerted pressure to a tooth surface by an arch wire, a spring, a rubber string, and a magnet. However, as the prior art is a technique for manufacturing an orthodontic brace (brackets), the technique does not describe about a tooth movement measuring method by comparison of a superposition of a maxilla and a mandible at all.

In order to make up for the problem, recently, measuring a shape of teeth or an oral structure more systematically and accurately by using a three dimensional scanner using a laser beam which is used in engineering field instead of a plaster model is tried.

However, a contemporary three dimensional measuring system is used in a simple measurement and analysis of the oral structure at a certain moment only. An oral structure or a mandibulofacial anatomic structure and teeth dynamically change by treatment or in length of time and especially in orthodontics, a lot of teeth movements occur after treatment.

A measurement of the change is evaluated as a most important factor in evaluation of diagnosis and result of treatment. However, with the present three dimensional measuring system, that the measurement at a certain moment only is possible, especially, setting a reference line, a reference plane, or a reference space for three dimensionally measuring a change of an anatomic structure such as a maxilla or a mandible is impossible and that there has been no development in a method for automating the setting process are regarded as biggest obstacles.

Therefore, until now, it is true that measuring by two dimensional manual process using a conventional X-ray image or depending on a CT (computer tomography) in order to measure the change. The method using X-ray can cause lot of clinical problems that a patient gets lots of radioactive doses and is imposed of financial burden and that it is complicated in operation as well as problems of efficiency and accuracy. Still, an error generated in performing a measuring process of a three dimensional structure as a two dimensional planar measurement process is indicated as a huge obstacle in diagnosis and prognosis judgment.

### SUMMARY OF THE INVENTION

The present invention has been proposed in order to overcome the above-described problems. In other words, an automatic tooth movement measuring method employing a three dimensional reverse engineering technique in accordance with the present invention first forms two three dimensional digital models which change corresponding to time. Space coordinates are applied to each formed model and a technique which superposes each model is applied. It is, therefore, an object of the present invention to provide method which a quantitatively and qualitatively measures a dentoalveolar movement of mandible, i.e., DMM, a skeletodentoalveolar movement of mandible, i.e., SDMM or a dentoalveolar movement of maxilla.

It is another object of the present invention to enable quantitatively and qualitatively measuring a position change of anatomic structure and teeth at the mandible which was regarded impossible due to a lack of a stable structure in a conventional method.

It is still another object of the present invention to provide a method which does not require a patient to be exposed to a huge amount of irradiation such as measuring by a lateral cephalometry or a tomography in measuring the movement of teeth. In other words, to provide a method which quantitatively and qualitatively measures the movement of teeth by applying space coordinates to the three dimensional digital model by a laser beam scanning.

In order to achieve the above-described objects, in accordance with an aspect of the present invention, there is provided an automatic tooth movement measuring method employing a three dimensional reverse engineering technique, wherein an automatic tooth movement measuring device employing a three dimensional reverse engineering technique quantitatively measures a position change of a tooth by using a digital model by a three dimensional scanning, including the steps of: (a) by a three dimensional scanning data of a maxilla and a mandible at a certain point of time (hereinafter referred to as a first point of time) and another point of time (hereinafter referred to as a second point of time) after the first point of time, forming respective three dimensional models of the maxilla and the mandible at the first point of time and at the second point of time respectively; (b) forming a three dimensional maxillary and madibular model of an occlusal status at the first point of time and at the second point of time respectively (hereinafter referred to as an occlusal model of the maxilla and the mandible) at the first point of time and at the second point of time by an occlusal external shape model of a maxilla and a mandible, wherein the occlusal status of the maxilla and the mandible is formed from the three dimensional scanning data of an oral occlusal status of the tooth of a real patient or a manually manufactured plaster model and the occlusal model of the maxilla and the mandible formed at the step (a); (c) forming a three dimensional reference coordinate system on a maxillary model formed at the first point of time; (d) superimposing the maxillary model formed at the second point of time to the maxillary model formed at the first point of time wherein the reference coordinate system is formed; (e) obtaining coordinates of the maxilla at the first point of time and at the second point of time and obtaining the amount of movement by using the reference coordinate system formed; (f) using the three dimensional reference coordinate system formed at the maxillary model as a reference coordinate system of the mandibular model in the occlusal model of the maxilla and the mandible at the first point of time; and (g) obtaining coordinates of the mandible at the first point of time and at the second point of time and obtaining the amount of change by applying the reference coordinate system formed in the mandibular model at the first point of time at the step (f) to the occlusal model of the maxilla and the mandible formed at the step (b).

The three dimensional scanning of the step (b) can be a scanning in front of an oral occlusal status of a tooth of a real patient or a manually manufactured plaster model.

Preferably, it is desirable that the superimposition of the step (d) is accomplished by coinciding regions which do not change after an orthodontic treatment in the maxillary model (hereinafter referred to as a reference region).

And, it is desirable that the automatic tooth movement measuring method further comprises the step of indicating distinguishable colors to superposed two models after the superposition.

The step of setting the three dimensional reference coordinate system of the step (c) can comprise the steps of: C1) forming a plane which passes more than two points on the PMRJ and on the midpalatal suture area as an X-Y plane; c2) determining a plane including the PMRJ and perpendicular to the X-Y plane as an X-Z; and c3) forming a plane including the PMRJ perpendicular to the X-Y plane and the X-Z plane as a Y-Z plane.

It is desirable that the method forming the occlusal model of the maxilla and the mandible of the step (b) is performed by superimposing the maxillary model and the mandibular model at the first point of time formed at the step of (a) at the maxillary position and the mandibular position appearing in the occlusal external shape model of the maxilla and the mandible at the first point of time respectively, and superposing the maxillary model and the mandibular model at the second point of time formed at the step of (a) at the maxillary position and the mandibular position appearing in the occlusal external shape model of the maxilla and the mandible at the first point of time respectively.

The step of (h1) obtaining the DMM by superimposing mandible at the first point of time and at the second point of time after taking impression and stably superimposing a mylohyoid ridge inside of the mandibular lingual can be further included after the step of (g).

And the step of (h2) obtaining the SMM at the region of the region after getting a three dimensional coordinate of an origin and a terminal of a buccal frenum and a labial frenum and measuring the difference can be further included after the step of (g).

In accordance with another aspect of the present invention, a recording medium recording a program for an automatic tooth movement measurement employing a three dimensional reverse engineering technique wherein the recording medium is recorded with program quantitatively measuring a position change of a tooth by forming a digital model of the tooth from a digital data by a three dimensional scanning comprises the functions of: analyzing the three dimensionally scanned data and analyzing the data on a screen in a three dimensional graphic; superposing more than two models which are three dimensionally scanned respectively by coinciding to a region which does not change after the tooth movement; displaying coordinate axis by setting a three dimensional coordinate system corresponding to a previously set data to the three dimensionally scanned model, and coordinate setting recognizing each point on the scanned model as a coordinate corresponding to the coordinate system; and quantitative movement measurement analyzing the tooth movement of a maxilla, SDMM and DMM by superposing more than two models formed by three dimensionally scanning before and after an orthodontic treatment by the superimposing function and analyzing as a coordinate by the coordinate setting function.

It is desirable that the superimposition function comprises the function capable of analyzing by the time of the tooth movement status by setting more than two superimposed models with differentiable colors respectively.

### BRIEF DESCRIPTION OF THE DRAWINGS

The above and other objects and features of the present invention will become apparent from the following description of the preferred embodiments given in conjunction with the accompanying drawings, in which:

FIG. 1 is a flowchart showing an automatic tooth movement measuring method employing a three dimensional reverse engineering technique in accordance with the present invention;

FIG. 2 is a diagram illustrating shapes of three dimensional models formed at steps shown in the flowchart of FIG. 1;

FIG. 3 is a picture illustrating an area which does not change after an orthodontic treatment in a maxillary model;

FIG. 4A is a side view illustrating an X-Y plane in setting a coordinate system of the maxillary model;

FIG. 4B is a top view illustrating an X-Z plane in setting a coordinate system of the maxillary model;

FIG. 4C is a front view illustrating a Y-Z plane in setting a coordinate system of the maxillary model;

FIG. 5 is a picture illustrating superposed feature of models before and after the orthodontic treatment of maxilla, with the automatic tooth movement measuring method employing a three dimensional reverse engineering technique in accordance with the present invention performed;

FIG. 6 is a picture illustrating a region which does not change after an orthodontic treatment in a mandibular model; and

FIG. 7 is a front view illustrating a stable anatomic oral structure which is selected for measuring a skeletal movement of mandible.

### DETAILED DESCRIPTION OF THE INVENTION

Hereinafter, preferred embodiments of the present invention are described in detail with respect to the accompanying drawings.

Before describing the embodiments of the present invention, the terms and words used in the specification and claims must not be interpreted in their usual or dictionary sense, but are to be interpreted as broadly as is consistent with the technical thoughts of the invention disclosed herein based upon the principle that the inventor can define the concepts of the terms properly in order to explain the invention in the best way.

Accordingly, the embodiments described in this specification and the construction shown in the drawings are nothing but one preferred embodiment of the present invention, and it does not cover all the technical ideas of the invention. Thus, it should be understood that various changes and modifications may be made upon the point of time of this application.

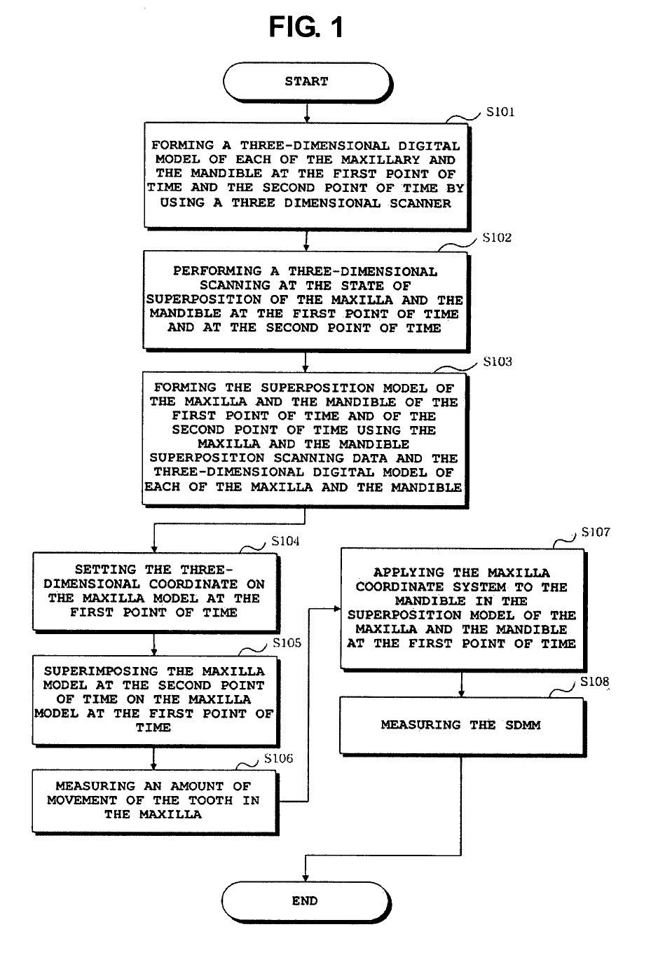

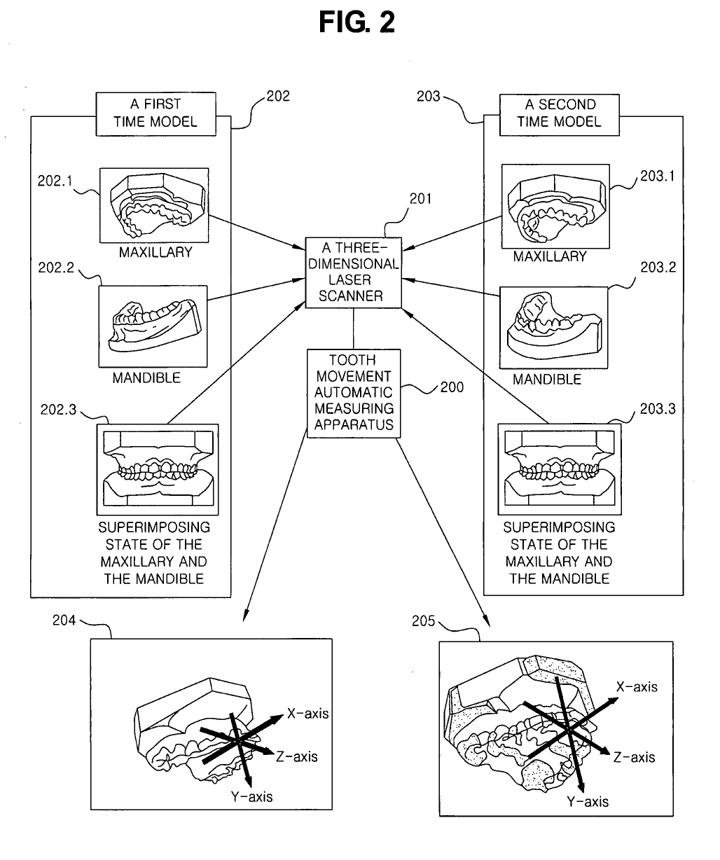

FIG. 1 is a flowchart showing an automatic tooth movement measuring method employing a three dimensional reverse engineering technique in accordance with the present invention. Shapes of three dimensional models formed in steps of the flowchart are illustrated in FIG. 2. A three dimensional reverse engineering technique is generating a virtual three dimensional digital model after coordinating in a three dimensional space in a computer by scanning using a three dimensional scanner. This means making a conventional orthodontic impression taking process into a data capable of processing by computerizing.

The automatic tooth movement measuring method employing a three dimensional reverse engineering technique in accordance with the present invention is realized by a computer or an exclusive device (hereinafter referred to as an automatic tooth movement measuring device 200 as a uniting concept) loaded with a software which performs the method. The software analysis and processes a data which is scanned by a three dimensional scanner using a laser beam, and performs a function of displaying on a screen.

Hereinafter, referring to FIG. 1 and FIG. 2, an automatic tooth movement measuring method is described step by step.

Referring to drawings, first, the automatic tooth movement measuring device 200 forms three dimensional models 202.1, 202.2, 203.1, 203.2 corresponding to a maxilla and a mandible of teeth respectively using a data which is teeth scanned by the three dimensional laser scanner 201 at a certain point of time (hereinafter referred as a first point of time) and at another certain point of time (hereinafter referred to as a second point of time) afterwards S101. The first point of time can be before the orthodontic treatment or a portion of the treatment has been done, and the second point of time is desirable when the orthodontic treatment has progressed further after the first point of time.

As illustrated above, the automatic tooth movement measuring device 200, after forming three dimensional models 202.1, 202.2, 203.1, 203.2 corresponding to the maxilla and the mandible respectively at the first point of time and at the second point of time, and at the first point of time and the second point of time respectively, performs scanning at a state of superimposition of the maxilla and the mandible S102. This can be performed to an oral occlusion status of a real patient or a manually manufactured plaster model, and can be mainly made through a scanning at a front of the occlusal status. The automatic tooth movement measuring device 200 forms an occlusal model 202.3, 203.3 of the maxilla and the mandible by using a scanning data of the occlusal status of the maxilla and the mandible at the first point of time and at the second point of time S103. In other words, in the external occlusal shape model of the maxilla and the mandible made by the scanning data of the occlusion status, the three dimensional maxillary model 202.1, 203.1 formed at the previous step is superposed at a position of the maxilla. And, the occlusal model of the maxilla and the mandible 202.3, 203.3 is formed by superimposing the three dimensional mandibular model 202.2, 203.2 formed at a previous step at the position of the mandible. As the superimposition of the three dimensional model 202.1, 202.2, 203.1, 203.2 corresponding to each maxilla and mandible and the occlusal model 202.3, 203.3, is performed with models of the first point of time in case of the first point of time, and with models of the second point of time in case of the second point of time, the superposed maxilla and the superimposed mandible exactly agrees respectively.

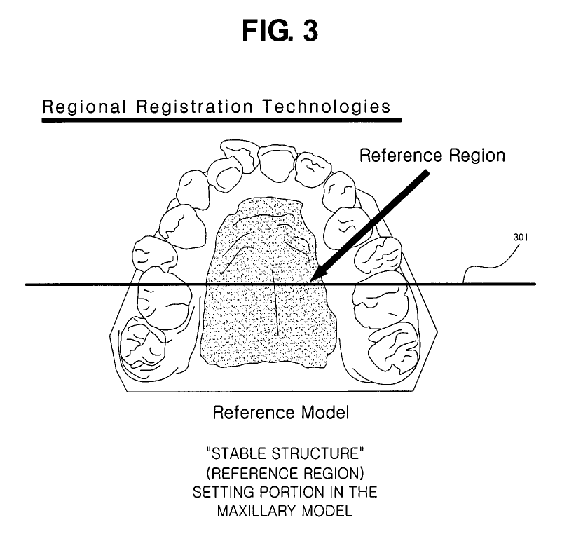

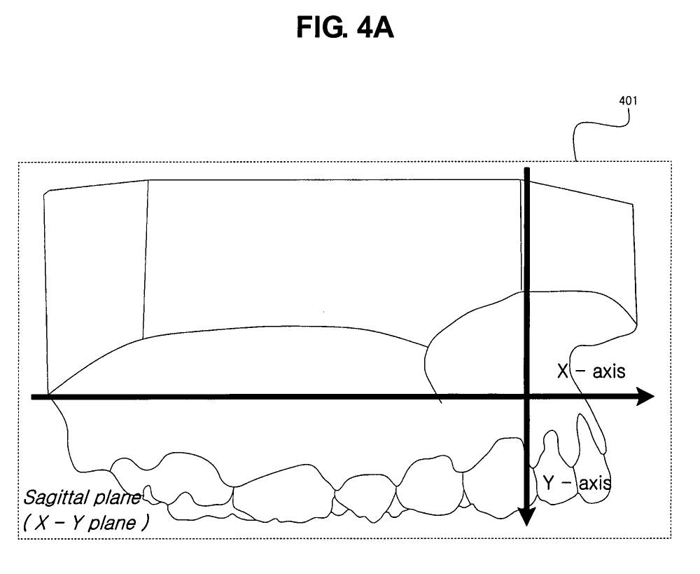

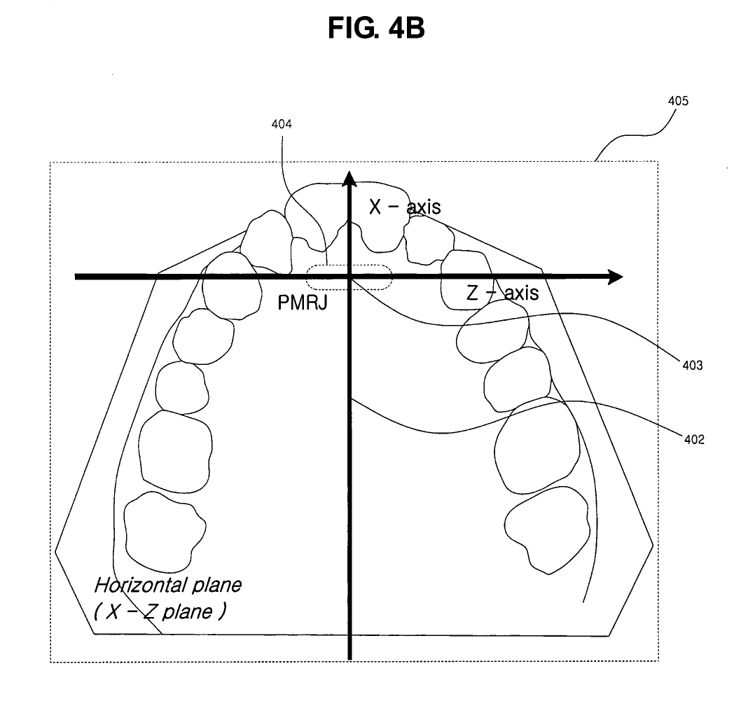

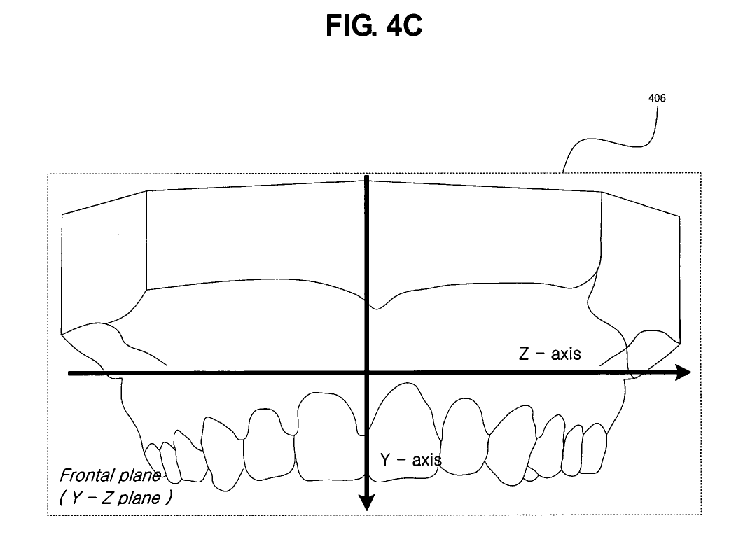

After this, the automatic tooth movement measuring device 200 sets a three dimensional coordinate system 204 at the maxillary model of the first point of time S104. This coordinate system becomes a means for measuring quantitatively the tooth movement status after the orthodontic treatment. Setting a coordinate is described afterwards referring to FIG. 4A, FIG. 4B, and FIG. 4C. And the automatic tooth movement measuring device 200 superposes the maxillary model 203.1 at the first point of time to the maxillary model 202.1, wherein the three dimensional coordinate system is set S105. As a result, the occlusal model of the maxilla and the mandible at the first point of time is superposed to the occlusal model of the maxilla and the mandible at the second point of time. After that, the amount of the tooth movement from the first point of time to the second point of time is measured by the coordinate system S106. The superimposition is performed in a way which coincide an anatomic area (stable superposition area) which does not change after the treatment to become a reference. The stable superposition area will be described referring to FIG. 3.

In a movable SDMM measurement, a new coordinate system is not set and the maxillary coordinate system, a basilar coordinate system which can be used as a stable coordinate system, is used as it is. In the occlusal model of the maxilla and the mandible formed at the first point of time 202.3, the coordinate system which is set on the maxilla is used as a mandibular coordinate system as it is S107. In other words, an origin of the mandibular coordinate system is set as an origin of the maxillary coordinate system. The automatic tooth movement measuring device 200 measures the SDMM by the coordinate system which was set in the mandible before S108.

FIG. 3 is a picture illustrating a ‘stable structure’ region (Hereinafter referred as a reference region) which does not change after an orthodontic treatment in a maxillary model. Referring to the drawing, the reference region which is a stable structure of the maxillary model is indicated with an arrow. When the amount of tooth movement is measured by superimposing the maxilla before and after the orthodontic treatment, the superimposition is performed in a way which coincide the reference region of the maxilla.

FIG. 4A is a side view illustrating an X-Y plane 401 in setting a coordinate system of the maxillary model. FIG. 4B is a top view illustrating an X-Z plane 405 in setting a coordinate system of the maxillary model. And FIG. 4C is a front view illustrating a Y-Z plane 406 in setting a coordinate system of the maxillary model. Referring to drawings, the X-Y plane 401 (anatomically referred to as a sagittal plane) is determined by a midpalatal suture 402 and a PMRJ 403. In here, the midpalatal suture 402 refers to an anatomical structure which illustrates a central line bisecting a symmetry of maxillary palate (concave portion) (Refer to an X-axis line of FIG. 4B). And, the PMRJ(403, junction of the incisive papilla and midpalatal suture) is a junction of an incisive papilla 404 and a midpalatal suture 402 and corresponds to a projecting gum tissue on the symmetrical central line of the frontal area of palate.

The X-Z plane 405 is determined as a plane which includes the PMRJ 403 and is perpendicular to the X-Y plane 401. This plane is a parallel plane with an occlusal plane which optimally passes through a maxillary buccal cusp tip of a first, second premolar and a mesiobuccal cusp tip of a first molar.

The Y-Z plane 406 is determined as a plane which includes the PMRJ 403 and is perpendicular to the X-Y plane 401 and the Z-X plane 405.

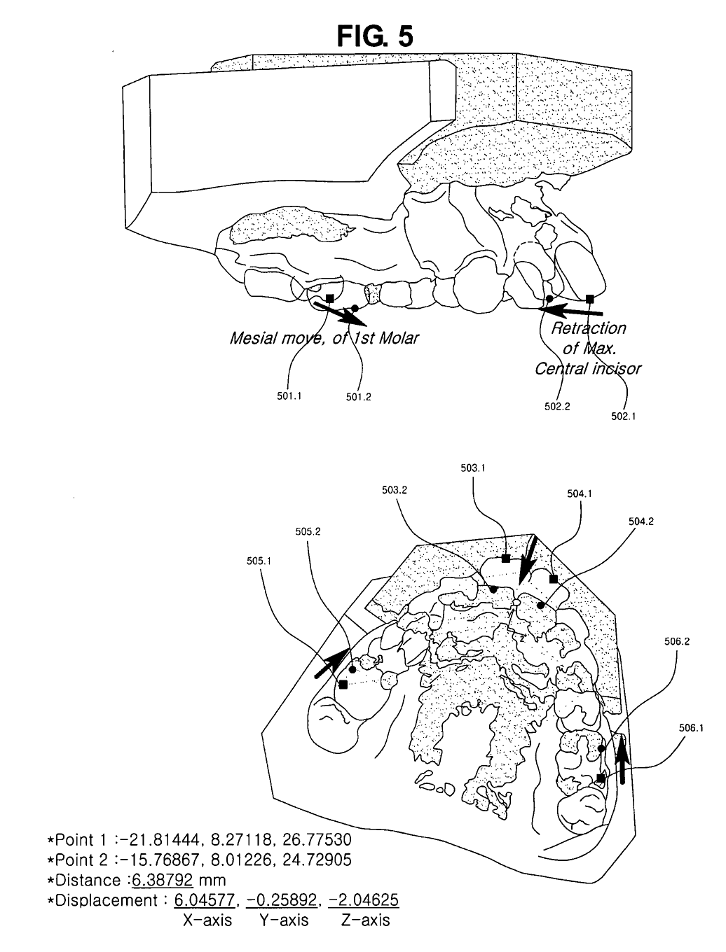

FIG. 5 is a picture illustrating superimposed feature of models before and after the orthodontic treatment of maxilla, with the automatic tooth movement measuring method employing a three dimensional reverse engineering technique in accordance with the present invention performed. Referring to the drawing, a red model is a model at the first point of time and a blue model is a model at the second point of time. In the drawing, each dot on the teeth at the first point of time is indicated as ‘˜0.1’, and each dot on the teeth at the second point of time is indicated as ‘˜0.2’. As an example, a point which is indicated as ‘501.1’ at the first point of time is moved to be indicated as ‘501.2’ at the second point of time after the orthodontic treatment.

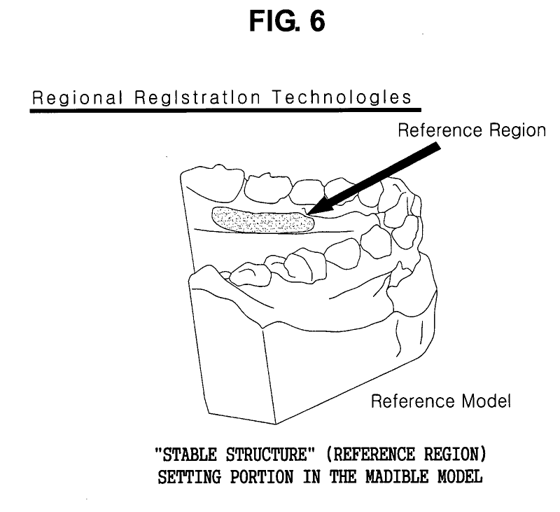

FIG. 6 is a picture illustrating a region which does not change after an orthodontic treatment in a mandibular model. Referring to the drawing, a reference region, a stable structure of the mandibular model is indicated with an arrow. When the automatic tooth movement measuring device 200 super imposes mandibles before and after the orthodontic treatment and measures the tooth movement, the superimposition is performed in a way that reference regions are coincided.

Until now, as the mandible has been regarded that the superimposition between the first point of time and the second point of time due to the lack of a stable structure is impossible, so initially the SDMM measuring method has been developed. However, for the measurement of pure DMM, a new mandibular superimposition method can be used complementarily together with the above method. In other words, it is possible to measure the DMM by superposing mandibles at the first point of time and the second point of time by taking impression and stably superimposing a mylohyoid ridge inside of a lingual mandibular area which is regarded as a stable region of a mandibular body by using a commercial oral scanner or by an individualized mandibular impression taking method and stably superimposing. The mylohyoid ridge is a region where a bone which exists in a mandibular linguae is protruded, a name for an anatomic structure of a mandible, and an expression of “impression taking” is used to mean taking impression so that region can be reproduced well and indicating this region in a formed model in impression taking.

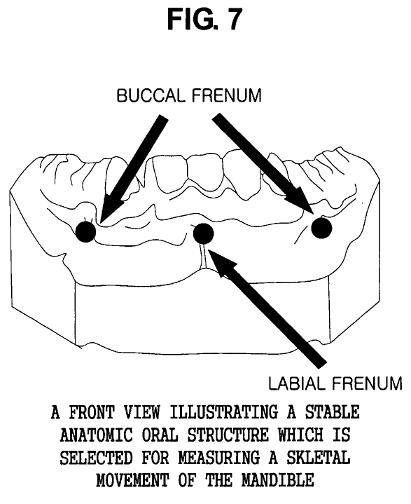

FIG. 7 is a front view illustrating a stable anatomic oral structure which is selected for measuring a skeletal movement of mandible. A mandible is an anatomic structure where a movable rotation and translation of condyle are performed, and the skeletal movement of mandible (hereinafter referred to as an SMM) at a certain region can be different from region to region. Therefore, in order to draw a pure SMM or DMM from the measured SDMM at a certain region, the automatic tooth movement measuring device 200 first gets a three dimensional coordinate of an origin and a terminal of a buccal frenum and a labial frenum which is thought to be a comparatively stable structure among an oral anatomic structure and measures the difference. Afterwards, it is possible to get a rough SMM at the region and therefore, an arithmetic measurement of the DMM is possible.

According to another preferable embodiment of the present invention, using the measured SDMM after the step S108 of FIG. 1, a step which measures the SMM or the DMM (not shown) can be added. In here, the relation of the SDMM, the DMM, and the SMM is SDMM−DMM=SMM. Therefore, as the SDMM is obtained at the step S108, if one value of the DMM or the SMM is obtained, the other value is calculated following the relation.

And, according to another embodiment of the present invention, the method for obtaining the DMM can use a commercial oral scanner. Or, the method for obtaining the DMM can be made by superposing mandibles at the first point of time and the second point of time by taking impression and stably superposing a ridge inside of a mandibular lingual which is regarded as a stable region of a mandibular body by using a commercial oral scanner or by an individualized mandibular impression taking method and stably superposing. As mentioned before, the mylohyoid ridge is a region where a bone which exists in a mandibular linguae is protruded, a name for an anatomic structure of a mandible, and an expression “impression taking” is used to mean taking impression so that region can be reproduced well and indicating this region in a formed model in impression taking.

Meanwhile, according to one embodiment of the present invention, a method for obtaining the SMM is capable of obtaining a rough SMM of the region after getting a three dimensional coordinate of an origin and a terminal of a buccal frenum and a labial frenum which is thought to be a comparatively stable structure among an oral anatomic structure and measuring the difference.

According to one aspect of the present invention, there is an effect capable of measuring the maxillary tooth movement and the SDMM quantitatively and qualitatively by forming two three dimensional models which change corresponding to the point of time, applying space coordinates to each model, and applying the method of superposing each model.

According to another aspect of the present invention, there is an effect capable of quantitatively and qualitatively measuring the movable SDMM, which was regarded impossible due to a lack of a stable structure in a conventional method by using the maxillary coordinate system.

According to another aspect of the present invention, there is an effect capable of quantitatively and qualitatively measuring the tooth movement by applying space coordinates to the three dimensional digital model by a laser beam scanning without requiring a patient to be exposed to a huge amount of irradiation such as measuring by a lateral cephalometry or a tomography in measuring the movement of teeth.

While the present invention has been described with respect to certain preferred embodiments, it will be apparent to those skilled in the art that various changes and modifications may be made without departing from the scope of the invention as defined in the following claims.

What is claimed is:

1. An automatic tooth movement measuring method employing a three dimensional reverse engineering technique, wherein an automatic tooth movement measuring device employing a three dimensional reverse engineering technique quantitatively measures a position change of a tooth by using a digital model by a three dimensional scanning, comprising the steps of:
(a) by a three dimensional scanning data of a maxilla and a mandible at a certain point of time (hereinafter referred to as a first point of time) and another point of time (hereinafter referred to as a second point of time) after the first point of time, forming respective three dimensional models of the maxilla and the mandible at the first point of time and at the second point of time respectively;
(b) forming a three dimensional model of an occlusal status at the first point of time and at the second point of time respectively (hereinafter referred to as an occlusal model of the maxilla and the mandible) at the first point of time and at the second point of time by an occlusal external shape model of a maxilla and a mandible, wherein the occlusal status of the maxilla and the mandible is formed from the three dimensional scanning data of an oral occlusal status of the tooth of a real patient or a manually manufactured plaster model and the occlusal model of the maxilla and the mandible formed at the step (a);
(c) forming a three dimensional reference coordinate system on a maxillary model formed at the first point of time;
(d) superimposing the maxillary model formed at the second point of time to the maxillary model formed at the first point of time wherein the reference coordinate system is formed;
(e) obtaining coordinates of the maxilla at the first point of time and at the second point of time and obtaining the amount of movement by using the reference coordinate system formed;
(f) using the three dimensional reference coordinate system formed at the maxillary model as a reference coordinate system of the mandibular model in the occlusal model of the maxilla and the mandible at the first point of time; and
(g) obtaining coordinates of the mandible at the first point of time and at the second point of time and obtaining the amount of change by applying the reference coordinate system formed in the mandibular model at the first point of time at the step (f) to the occlusal model of the maxilla and the mandible formed at the step (b).

2. The automatic tooth movement measuring method as recited in claim 1, wherein the three dimensional scanning of the step (b) has a characteristic in scanning in front of an oral occlusal status of a tooth of a real patient or a manually manufactured plaster model.

3. The automatic tooth movement measuring method as recited in claim 1, wherein the superposition of the step (d) is accomplished by coinciding regions which do not change after an orthodontic treatment in the maxillary model (hereinafter referred to as a reference region).

4. The automatic tooth movement measuring method as recited in claim 3, further comprising the step of indicating distinguishable colors to superposed two models after the superposition.

5. The automatic tooth movement measuring method as recited in claim 1, wherein the step of setting the three dimensional reference coordinate system of the step (c) comprises the steps of:
C1) forming a plane which passes more than two points on the PMRJ and on the midpalatal suture area as an X-Y plane;
c2) determining a plane including the PMRJ and perpendicular to the X-Y plane as an X-Z; and
c3) forming a plane including the PMRJ perpendicular to the X-Y plane and the X-Z plane as a Y-Z plane.

6. The automatic tooth movement measuring method as recited in claim 1, wherein the method forming the occlusal model of the maxilla and the mandible of the step (b) has a characteristic in superimposing the maxillary model and the mandibular model at the first point of time formed at the step of (a) at the maxillary position and the mandibular position appearing in the occlusal external shape model of the maxilla and the mandible at the first point of time respectively, and superimposing the maxillary model and the mandibular model at the second point of time formed at the step of (a) at the maxillary position and the mandibular position appearing in the occlusal external shape model of the maxilla and the mandible at the first point of time respectively.

7. The automatic tooth movement measuring method as recited in claim 1, further comprising the step of (h1) obtaining the DMM by superimposing mandibular bones at the first point of time and at the second point of time after taking impression and stably superposing a mylohyoid ridge inside of the mandibular lingual after the step of (g).

8. The automatic tooth movement measuring method as recited in claim 1, further comprising the step of (h2) obtaining the SMM at the region of the region after getting a three dimensional coordinate of an origin and a terminal of a buccal frenum and a labial frenum and measuring the difference after the step of (g).

9. A recording medium recording a program for an automatic tooth movement measurement employing a three dimensional reverse engineering technique wherein the recording medium is recorded with program quantitatively measuring a position change of a tooth by forming a digital model of the tooth from a digital data by a three dimensional scanning, comprising the functions of:
analyzing the three dimensionally scanned data and analyzing the data on a screen in a three dimensional graphic;
superposing more than two models which are three dimensionally scanned respectively by coinciding to a region which does not change after the tooth movement;
displaying coordinate axis by setting a three dimensional coordinate system corresponding to a previously set data to the three dimensionally scanned model, and coordinate setting recognizing each point on the scanned model as a coordinate corresponding to the coordinate system; and
quantitative movement measurement analyzing the tooth movement of a maxilla, SDMM and DMM by superposing more than two models formed by three dimensionally scanning before and after an orthodontic treatment by the superposing function and analyzing as a coordinate by the coordinate setting function.

10. The recording medium as recited in claim 9, wherein the superposition function has a characteristic in comprising the function capable of analyzing by the time of the tooth movement status by setting more than two superposed models with differentiable colors respectively.
